(19) United States
(12) Patent Application Publication
(10) Pub. No.: US 2025/0091321 A1
(43) Pub. Date: Mar. 20, 2025

(54) Fire Resistant Gypsum Panel

(71) Applicant: Gold Bond Building Products, LLC, Charlotte, NC (US)

(72) Inventors: Veda Evans, Charlotte, NC (US); Ratnasabapathy Gurunathan Iyer, Charlotte, NC (US); Joseph J. Bailey, Charlotte, NC (US)

(21) Appl. No.: 18/889,477

(22) Filed: Sep. 19, 2024

Related U.S. Application Data
(60) Provisional application No. 63/583,884, filed on Sep. 20, 2023.

(51) Int. Cl. B32B 13/08; B32B 5/02; C04B 14/06; C04B 14/20; C04B 14/30; C04B 28/14; C04B 111/00

(52) U.S. Cl. CPC B32B 13/08; B32B 5/022; C04B 14/06; C04B 14/202; C04B 14/303; C04B 28/14; B32B 2260/021; B32B 2262/101; B32B 2262/105; B32B 2262/108; B32B 2264/1021; B32B 2264/1023; B32B 2264/301; B32B 2307/304; C04B 2111/0062

(57) ABSTRACT

The present disclosure is directed to a gypsum panel and a method of making a gypsum panel. For instance, the gypsum panel comprises: a first facing material having an outer surface and an inner surface opposing the outer surface; a thermal barrier layer adjacent the inner surface of the first paper material, the thermal barrier layer comprising a thermal additive; a gypsum core having an outer surface facing the thermal barrier layer and an inner surface opposing the outer surface, the gypsum core comprising a first filler comprising silica, alumina, or a mixture thereof; and a second facing material adjacent the inner surface of the gypsum core.

### CROSS-REFERENCE TO RELATED APPLICATION

The present application claims filing benefit of U.S. Provisional Patent Application No. 63/583,884 having a filing date of Sep. 20, 2023, which is hereby incorporated by reference in its entirety.

### BACKGROUND

Gypsum panels are commonly employed in drywall construction of walls and ceilings. Generally, these gypsum panels are formed from a gypsum slurry including a mixture of calcined gypsum (i.e., stucco), water, and other conventional additives. These conventional additives may be utilized to provide a gypsum panel having certain attributes. As one example, certain additives may assist with the fire resistance properties of the gypsum panel. When exposed to intense heat, such as that generated by fire, the gypsum panel is generally expected to stay in place for some length of time and serve as an insulation barrier to deter the spread of fire. In this regard, generally, fire resistance can be measured by the period which a gypsum panel can withstand a standard fire test.

As a result, there is a need to provide a gypsum panel with improved fire resistance properties.

### SUMMARY

In accordance with one embodiment of the present disclosure, a gypsum panel is disclosed. The gypsum panel comprises: a first facing material having an outer surface and an inner surface opposing the outer surface; a thermal barrier layer adjacent the inner surface of the first facing material, the thermal barrier layer comprising a thermal additive; a gypsum core having an outer surface facing the thermal barrier layer and an inner surface opposing the outer surface, the gypsum core comprising a first filler comprising silica, alumina, or a mixture thereof; and a second facing material adjacent the inner surface of the gypsum core.

In accordance with another embodiment of the present disclosure, a method of making a gypsum panel is disclosed. The method comprises: providing a first facing material; depositing a thermal additive adjacent an inner surface of the first facing material to form a thermal barrier layer; depositing a gypsum slurry comprising stucco, water, and a first filler comprising silica, alumina, or a mixture thereof adjacent the thermal barrier layer; providing a second facing material adjacent the gypsum slurry; and allowing the stucco to convert to calcium sulfate dihydrate to form a gypsum core.

### BRIEF DESCRIPTION OF THE DRAWINGS

The invention will now be described, by way of example, with reference to the accompanying drawings, in which:

FIG. 1 illustrates the heating profile of Example 1 and ASTM E119-20a;

FIG. 2 illustrates the temperature of the gypsum panels of Example 1 as a function of time; and

FIG. 3 illustrates an enlarged view of FIG. 2 at earlier times.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present disclosure is directed to a gypsum panel and a method of making a gypsum panel. In particular, the gypsum panel comprises a first facing material, such as a first paper facing material, a thermal barrier layer, a gypsum core comprising a first filler comprising silica, alumina, or a mixture thereof, and a second facing material. The present inventors have discovered that the gypsum panel as disclosed herein can have various benefits.

For instance, without intending to be limited, the present inventors have discovered that the gypsum panel may exhibit a desired fire resistance. In particular, the present inventors have discovered that the thermal barrier layer may assist with reducing the rate of heat transfer through the gypsum panel. For instance, without intending to be limited, incorporation of the first filler within the gypsum panel may assist with reducing and/or lowering the rate of thermal transfer to the gypsum core thereby lengthening the time of conversion from dihydrate to hemihydrate crystals. In addition, without intending to be limited, the incorporation of the first filler may assist with minimizing the effect of shrinkage of the gypsum panel upon exposure to heat. For instance, upon exposure to heat, the gypsum crystals within the gypsum panel may shrink due to the conversion of the dihydrate crystals to hemihydrate or hemihydrate and anhydrite. As a result, incorporation of the first filler within the gypsum panel may assist with maintaining the structural integrity of the gypsum panel for a longer period of time than otherwise. In this regard, use of the thermal barrier layer and/or the first filler may assist with extending the time to failure as defined under ASTM E119-20a.

In addition, in some embodiments, an assembly may be constructed using gypsum panels of the present disclosure wherein the assembly may conform to the specification of Underwriters Laboratories, Inc. (UL®) assemblies, such as U419, U305, and U423. For a fire test, the face of one side of the assembly can be exposed to increasing temperatures for a period of time in accordance with a heating curve, such as those discussed in ASTM E119-20a. The temperatures proximate the heated side and the temperatures at the surface of the unheated side of the assembly are monitored during the tests to evaluate the temperatures experienced by the exposed gypsum panels and the heat transmitted through the assembly to the unexposed panels.

In this regard, in one embodiment, an assembly of gypsum panels formed according to the present disclosure and in accordance with the specification of a U419 assembly, with or without cavity insulation, may have a fire rating of at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-20a. The fire rating may be 75 minutes or less, such as 73 minutes or less, such as 71 minutes or less, such as 70 minutes or less, such as 69 minutes or less, such as 68 minutes or less, such as 67 minutes or less, such as 66 minutes or less, such as 65 minutes or less, such as 64 minutes or less, such as 63 minutes or less, such as 62 minutes or less, such as 61 minutes or less.

In one embodiment, an assembly of gypsum panels formed according to the present disclosure and in accordance with the specification of a U305 assembly may have a fire rating of at least about 55 minutes, such as at least about 55.5 minutes, such as at least about 56 minutes, such as at least about 56.5 minutes, such as at least about 57 minutes, such as at least about 57.5 minutes, such as at least about 58 minutes, such as at least about 58.5 minutes, such as at least about 59 minutes, such as at least about 59.5 minutes, such as at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-20a. The fire rating may be 75 minutes or less, such as 73 minutes or less, such as 71 minutes or less, such as 70 minutes or less, such as 69 minutes or less, such as 68 minutes or less, such as 67 minutes or less, such as 66 minutes or less, such as 65 minutes or less, such as 64 minutes or less, such as 63 minutes or less, such as 62 minutes or less, such as 61 minutes or less.

In one embodiment, an assembly of gypsum panels formed according to the present disclosure and in accordance with the specification of a U423 assembly may have a fire rating of at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-20a. The fire rating may be 75 minutes or less, such as 73 minutes or less, such as 71 minutes or less, such as 70 minutes or less, such as 69 minutes or less, such as 68 minutes or less, such as 67 minutes or less, such as 66 minutes or less, such as 65 minutes or less, such as 64 minutes or less, such as 63 minutes or less, such as 62 minutes or less, such as 61 minutes or less.

As indicated herein, a gypsum panel is disclosed. The gypsum panel comprises a gypsum core, a thermal barrier layer, and a first facing material, such as a first paper facing material, and a second facing material sandwiching the gypsum core and the thermal barrier layer.

In general, the gypsum core may comprise calcium sulfate dihydrate. The gypsum utilized in forming the gypsum slurry and resulting core may be from a natural source or a synthetic source and is thus not necessarily limited by the present disclosure. In addition, the gypsum may be from a virgin source or a reclaim source. In the event the gypsum is formed from a mixture of a virgin source or a reclaim source, the amount of each of the respective sources utilized is not limited. For instance, the amount may range from 0 wt. % or more to 100 wt. %, or less, along with any other weight percentages in 0.1 wt. % increments, based on the total weight of the gypsum. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less. In one embodiment, the aforementioned weight percentages are based on the weight of the gypsum core. In another embodiment, the aforementioned weight percentages are based on the weight of the gypsum panel. In a further embodiment, the aforementioned weight percentages are based on the weight of the solids in the gypsum slurry. The calcium sulfate dihydrate content of a gypsum panel may be determined using means generally known in the art. For instance, such means may include, but are not limited to, X-ray diffraction (XRD) analysis, gypsum phase analysis via thermogravimetric analysis (TGA), combined water/purity analysis.

In some aspects, a gypsum panel formed in accordance with the present disclosure may have a calcium sulfate hemihydrate content of about 0.01 wt. % to about 10 wt. %, such as about 0.01 wt. % or more, such as about 0.05 wt. % or more, such as about 0.1 wt. % or more, such as about 0.2 wt. % or more, such as about 0.5 wt. % or more, such as about 0.8 wt. % or more, such as about 0.9 wt. % or more, such as about 1 wt. % or more, such as about 1.2 wt. % or more, such as about 1.5 wt. % or more, such as about 2 wt. % or more, such as about 3 wt. % or more, such as about 4 wt. % or more, such as about 5 wt. % or more. Generally, the calcium sulfate hemihydrate content of the gypsum panel is less than about 10 wt. %, such as about 8 wt. % or less, such as about 5 wt. % or less, such as about 4 wt. % or less, such as about 3 wt. % or less, such as about 2 wt. % or less, such as about 1.5 wt. % or less, such as about 1 wt. % or less, such as about 0.9 wt. % or less, such as about 0.8 wt. % or less, such as about 0.5 wt. % or less, such as about 0.2 wt. % or less, such as about 0.1 wt. % or less. In one embodiment, the aforementioned weight percentages are based on the weight of the gypsum core. In another embodiment, the aforementioned weight percentages are based on the weight of the gypsum panel. The calcium sulfate hemihydrate content of a gypsum panel may be determined using means generally known in the art, such as by X-ray diffraction (XRD) analysis, thermogravimetric analysis, and/or combined water analysis.

In addition, the gypsum core comprises a first filler comprising silica, alumina, or a mixture thereof. In one embodiment, the gypsum core and/or the first filler comprise silica. In another embodiment, the gypsum core and/or first filler comprise alumina. In a further embodiment, the gypsum core and/or the first filler comprise a mixture of silica and alumina.

Generally, silica may be referred to as silicon dioxide. In particular, the silicon dioxide may be amorphous silicon dioxide. Also, alumina may generally be referred to as aluminum oxide. In particular, the aluminum oxide may be amorphous aluminum oxide.

In one embodiment, the silica in the gypsum panel may be or may be from a fumed silica, a precipitated silica, a colloidal silica, or a mixture thereof. In one embodiment, the silica in the gypsum panel may be or may be from a precipitated silica, a colloidal silica, or a mixture thereof. In one embodiment, the silica in the gypsum panel may be or may be from a colloidal silica.

In one embodiment, the silica may be from a colloidal silica. As generally known in the art, colloidal silica may be a suspension of fine, amorphous, generally spherical silica particles. Generally, colloidal silica may also be nonporous. In one embodiment, the silica particles in the colloidal silica may be monodisperse with respect to particle size. For instance, the deviation in particle size may be 10% or less, such as 5% or less, such as 3% or less, such as 2% or less, such as 1% or less. The particle size of may be determined using means known in the art, such as dynamic light scattering.

In one embodiment, the silica may be a precipitated silica. As generally known in the art, precipitated silica is produced by precipitation from a solution containing silicate salts. Generally, precipitated silica may be porous and may be present as an agglomerate. The precipitated silica may have a d50 of 500 nm or more, such as 1 μm or more, such as 2 μm or more, such as 3 μm or more, such as 5 μm or more, such as 10 μm or more, such as 15 μm or more, such as 25 μm or more to 100 μm or less, such as 75 μm or less, such as 50 μm or less, such as 40 μm or less, such as 25 μm or less, such as 20 μm or less, such as 15 μm or less, such as 10 μm or less, such as 5 μm or less, such as 4 μm or less, such as 1 μm or less. Such aforementioned d50, in one embodiment, may refer to the agglomerate size of the precipitated silica.

In one embodiment, the first filler, such as the silica, may have a surface modification. In general, modified forms may include, but are not limited to, modifications with ammonium, aluminate, chloride, silane, and deionized forms. As one example, the modification may be via an ammonium in one embodiment. In another embodiment, the modification may be via a chloride. In a further embodiment, the modification may be via an aluminate. For instance, the modification may be via sodium aluminate.

The first filler may have a particular particle size. For instance, the first filler, such as the silica, may have an average particle size of 1 nm or more, such as 2 nm or more, such as 3 nm or more, such as 5 nm or more, such as 10 nm or more, such as 15 nm or more, such as 20 nm or more, such as 25 nm or more, such as 30 nm or more, such as 40 nm or more, such as 50 nm or more, such as 60 nm or more, such as 70 nm or more, such as 80 nm or more, such as 90 nm or more, such as 100 nm or more, such as 200 nm or more, such as 300 nm or more, such as 400 nm or more, such as 500 nm or more, such as 600 nm or more, such as 700 nm or more, such as 800 nm or more, such as 900 nm or more, such as 1 μm or more, such as 2 μm or more, such as 3 μm or more, such as 4 μm or more, such as 5 μm or more, such as 6 μm or more, such as 7 μm or more, such as 8 μm or more, such as 9 μm or more, such as 10 μm or more, such as 15 μm or more, such as 20 μm or more, such as 25 μm or more, such as 30 μm or more, such as 40 μm or more, such as 50 μm or more, such as 60 μm or more, such as 70 μm or more, such as 80 μm or more, such as 90 μm or more. The average particle size may be 100 μm or less, such as 90 μm or less, such as 80 μm or less, such as 70 μm or less, such as 60 μm or less, such as 50 μm or less, such as 40 μm or less, such as 30 μm or less, such as 20 μm or less, such as 10 μm or less, such as 9 μm or less, such as 8 μm or less, such as 7 μm or less, such as 6 μm or less, such as 5 μm or less, such as 4 μm or less, such as 3 μm or less, such as 2 μm or less, such as 1 μm or less, such as 900 nm or less, such as 800 nm or less, such as 700 nm or less, such as 600 nm or less, such as 500 nm or less, such as 400 nm or less, such as 300 nm or less, such as 250 nm or less, such as 200 nm or less, such as 180 nm or less, such as 160 nm or less, such as 140 nm or less, such as 120 nm or less, such as 100 nm or less, such as 80 nm or less, such as 70 nm or less, such as 60 nm or less, such as 50 nm or less, such as 40 nm or less, such as 35 nm or less, such as 30 nm or less, such as 25 nm or less, such as 20 nm or less, such as 15 nm or less. In one embodiment, such average particle size may refer to an average particle diameter. For instance, such diameter may be utilized for generally spherical shaped fillers. In another embodiment for a non-generally spherical filler, the average particle size may refer to an average length, generally referring to the longest dimension of the filler. The average particle size may be determined using means known in the art, such as dynamic light scattering.

The first filler, such as the silica, may have a particular surface area. For instance, the first filler, such as the silica, may have an average surface area of 10 m²/g or more, such as 20 m²/g or more, such as 30 m²/g or more, such as 50 m²/g or more, such as 80 m²/g or more, such as 100 m²/g or more, such as 150 m²/g or more, such as 200 m²/g or more, such as 250 m²/g or more, such as 300 m²/g or more, such as 400 m²/g or more, such as 500 m²/g or more, such as 600 m²/g or more, such as 700 m²/g or more, such as 800 m²/g or more, such as 900 m²/g or more, such as 1000 m²/g or more, such as 1100 m²/g or more, such as 1200 m²/g or more, such as 1300 m²/g or more, such as 1400 m²/g or more, such as 1500 m²/g or more. The average surface area may be 2000 m²/g or less, such as 1800 m²/g or less, such as 1600 m²/g or less, such as 1400 m²/g or less, such as 1200 m²/g or less, such as 1100 m²/g or less, such as 1000 m²/g or less, such as 900 m²/g or less, such as 800 m²/g or less, such as 700 m²/g or less, such as 600 m²/g or less, such as 500 m²/g or less, such as 400 m²/g or less, such as 300 m²/g or less, such as 250 m²/g or less, such as 200 m²/g or less, such as 180 m²/g or less, such as 160 m²/g or less, such as 140 m²/g or less, such as 120 m²/g or less, such as 100 m²/g or less, such as 90 m²/g or less, such as 80 m²/g or less, such as 70 m²/g or less, such as 60 m²/g or less, such as 50 m²/g or less, such as 40 m²/g or less. The surface area may be determined using means known in the art, such as the Brunauer, Emmett and Teller theory and method.

In one embodiment, the silica and/or alumina may be provided as a colloid. For instance, the silica may be provided as a colloidal silica. Similarly, the alumina may be provided as a colloidal alumina. In one embodiment, the colloid may include a mixture of alumina and silica. When provided as a colloid, the colloid may be in a liquid form wherein the liquid may be water.

When provided as a colloid, the colloid may have a particular concentration of the silica and/or alumina. For instance, the silica and/or alumina, such as the silica, may be provided in a concentration of 2 wt. % or more, such as 3 wt. % or more, such as 5 wt. % or more, such as 7 wt. % or more, such as 10 wt. % or more, such as 13 wt. % or more, such as 15 wt. % or more, such as 18 wt. % or more, such as 20 wt. % or more, such as 22 wt. % or more, such as 25 wt. % or more, such as 28 wt. % or more, such as 30 wt. % or more, such as 33 wt. % or more, such as 35 wt. % or more, such as 38 wt. % or more, such as 40 wt. % or more, such as 43 wt. % or more, such as 45 wt. % or more, such as 48 wt. % or more, such as 50 wt. % or more. The concentration may be 70 wt. % or less, such as 65 wt. % or less, such as 60 wt. % or less, such as 55 wt. % or less, such as 52 wt. % or less, such as 50 wt. % or less, such as 47 wt. % or less, such as 45 wt. % or less, such as 42 wt. % or less, such as 40 wt. % or less, such as 37 wt. % or less, such as 35 wt. % or less, such as 32 wt. % or less, such as 30 wt. % or less, such as 27 wt. % or less, such as 25 wt. % or less, such as 22 wt. % or less, such as 20 wt. % or less, such as 18 wt. % or less, such as 16 wt. % or less, such as 14 wt. % or less, such as 12 wt. % or less, such as 10 wt. % or less.

Similarly, the colloid may have a particular solids content. For instance, the solids content may be 2% or more, such as 3% or more, such as 5% or more, such as 7% or more, such as 10% or more, such as 13% or more, such as 15% or more, such as 18% or more, such as 20% or more, such as 22% or more, such as 25% or more, such as 28% or more, such as 30% or more, such as 33% or more, such as 35% or more, such as 38% or more, such as 40% or more, such as 43% or more, such as 45% or more, such as 48% or more, such as 50% or more. The solids content may be 75% or less, such as 70% or less, such as 65% or less, such as 60% or less, such as 55% or less, such as 52% or less, such as 50% or less, such as 47% or less, such as 45% or less, such as 42% or less, such as 40% or less, such as 37% or less, such as 35% or less, such as 32% or less, such as 30% or less, such as 27% or less, such as 25% or less, such as 22% or less, such as 20% or less, such as 18% or less, such as 16% or less, such as 14% or less, such as 12% or less, such as 10% or less.

In addition, the colloid may have a particular pH. For instance, the pH may be 2 or more, such as 3 or more, such as 4 or more, such as 5 or more, such as 6 or more, such as 7 or more, such as 8 or more, such as 9 or more, such as 10 or more, such as 11 or more. The pH may be 12 or less, such as 11 or less, such as 10 or less, such as 9 or less, such as 8 or less, such as 7 or less, such as 6 or less, such as 5 or less, such as 4 or less, such as 3 or less.

In one embodiment, the colloid may be anionic. In this regard, it may be sodium-stabilized, ammonium-stabilized, or a mixture thereof. Accordingly, the colloid may have a pH of 8 or more, such as 9 or more, such as 10 or more. The pH may be 11 or less, such as 10 or less, such as 9 or less. In one embodiment, the colloid may be cationic. In another embodiment, the colloid may be deionized.

Generally, the first filler, such as the silica, may be present in the gypsum core in a particular amount. For instance, the first filler, such as the silica, may be present in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more, such as 0.45 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.5 wt. % or more, such as 2 wt. % or more, such as 3 wt. % or more, such as 4 wt. % or more, such as 5 wt. % or more. In some aspects, the first filler, such as the silica, may be present in an amount of 15 wt. % or less, such as 12 wt. % or less, such as 10 wt. % or less, such as 8 wt. % or less, such as 6 wt. % or less, such as 5 wt. % or less, such as 4 wt. % or less, such as 3 wt. % or less, such as 2 wt. % or less, such as 1.8 wt. % or less, such as 1.5 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.45 wt. % or less, such as 0.4 wt. % or less, such as 0.35 wt. % or less, such as 0.30 wt. % or less, such as 0.25 wt. % or less, such as 0.2 wt. % or less, such as 0.15 wt. % or less, such as 0.1 wt. % or less, such as 0.05 wt. % or less. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

The first filler, such as the silica, may be present in the gypsum panel in an amount of 0.0001 lbs/MSF to 50 lbs/MSF, including all increments of 0.0001 lbs/MSF therebetween. For instance, the first filler, such as the silica, may be present in the gypsum panel in an amount of 0.0001 lbs/MSF or more, such as 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 10 lbs/MSF or more, such as 20 lbs/MSF or more, such as 30 lbs/MSF or more, such as 40 lbs/MSF or more. Generally, the first filler, such as the silica, may be present in the gypsum panel in an amount of 50 lbs/MSF or less, such as 40 lbs/MSF or less, such as 30 lbs/MSF or less, such as 20 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

In general, the composition of the gypsum core is not necessarily limited and may include any additives as known in the art. For instance, the additives may include dispersants, foam or foaming agents including aqueous foam (e.g. sulfates such as alkyl sulfates, alkyl ether sulfates), set accelerators (e.g., ball mill accelerator, land plaster, sulfate salts, etc.), set retarders, binders, biocides (such as bactericides and/or fungicides), adhesives, pH adjusters, thickeners (e.g., Portland cement, fly ash, clay, celluloses, high molecular weight polymers, etc.), leveling agents, non-leveling agents, colorants, fire retardants or additives (e.g., silicates, expandable materials such as vermiculite, perlite, graphite, etc.), water repellants, fillers (e.g., glass spheres, glass fibers), natural and synthetic fibers (e.g. cellulosic fibers, microfibrillated fibers, nanocellulosic fibers, etc.), waxes (e.g., silicones, siloxanes, etc.), acids (e.g., boric acid), secondary phosphates (e.g., condensed phosphates or orthophosphates including trimetaphosphates, polyphosphates, and/or cyclophosphates, etc.), mixtures thereof, natural and synthetic polymers, starches (such as pregelatinized starch, non-pregelatinized starch, and/or an acid modified starch), sound dampening polymers (e.g., viscoelastic polymers/glues, such as those including an acrylic/acrylate polymer, etc.; polymers with low glass transition temperature, etc.), etc., and mixtures thereof. In general, it should be understood that the types and amounts of such additives are not necessarily limited by the present disclosure.

Each additive may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the aforementioned weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

In one embodiment, the gypsum core may contain an intumescent additive. The intumescent additive is not necessarily limited by the present disclosure. The intumescent additive may include a vermiculite, a perlite, a graphite, or a mixture thereof. In particular, such additive may be in an unexpanded form (also referred to as an expandable form). For example, the additive may be an unexpanded vermiculite, an unexpanded perlite, an unexpanded graphite, or a mixture thereof. By utilizing such additive, expansion of such additive may offset the shrinkage of a set gypsum.

In one embodiment, the gypsum core may include unexpanded vermiculite. Such unexpanded vermiculite may be any suitable grade as known in the art. For instance, the unexpanded vermiculite may be a Grade 1 vermiculite, a Grade 2 vermiculite, a Grade 3 vermiculite, a Grade 4 vermiculite, a Grade 5 vermiculite or a mixture thereof. For instance, in one embodiment, the unexpanded vermiculite may be a Grade 1 vermiculite. In another embodiment, the unexpanded vermiculite may be a Grade 2 vermiculite. In a further embodiment, the unexpanded vermiculite may be a Grade 3 vermiculite. In another further embodiment, the unexpanded vermiculite may be a Grade 4 vermiculite. In a further embodiment, the unexpanded vermiculite may be a Grade 5 vermiculite. Such grades are generally known in the art based on particular granule size.

In one embodiment, the unexpanded vermiculite may be a mixture of grades, such as a mixture of Grades 3 and 4, Grades 3 and 5, Grades 4 and 5, or Grades 3, 4, and 5. For instance, in one embodiment, the unexpended vermiculite may be a mixture of Grades 3 and 4. In another embodiment, the unexpended vermiculite may be a mixture of Grades 4 and 5. In a further embodiment, the unexpended vermiculite may be a mixture of Grades 3 and 5. In an even further embodiment, the unexpended vermiculite may be a mixture of Grades 3, 4, and 5.

In another embodiment, the gypsum core may not contain an intumescent additive. In one embodiment, the gypsum core may not contain a vermiculite, a perlite, and/or a graphite as mentioned above. For instance, the gypsum core may not contain a vermiculite in one embodiment. In another embodiment, the gypsum core may not contain a perlite. In one embodiment, the gypsum core may not contain graphite. In a further embodiment, the gypsum core may not contain at least any two of vermiculite, perlite, or graphite. In such embodiments, the amount may be 0.1 wt. % or less, such as 0.05 wt. % or less, such as 0.01 wt. % or less, such as 0.005 wt. % or less, such as 0.001 wt. % or less based on the weight of the gypsum core. In one embodiment, the aforementioned weight percentage may be based on the weight of the gypsum panel.

In one embodiment, the gypsum core may contain a vermiculite, a perlite, or a mixture thereof. In another embodiment, the gypsum core may not contain a vermiculite and/or a perlite. For instance, the gypsum core may not contain a vermiculite in one embodiment. In another embodiment, the gypsum core may not contain a perlite. In a further embodiment, the gypsum core may not contain vermiculite or perlite. In such embodiment, the amount may be 0.1 wt. % or less, such as 0.05 wt. % or less, such as 0.01 wt. % or less, such as 0.005 wt. % or less, such as 0.001 wt. % or less based on the weight of the gypsum core. In one embodiment, the aforementioned weight percentage may be based on the weight of the gypsum.

In addition to the gypsum core and the facing materials, the gypsum panel also comprises a thermal barrier layer including a thermal additive. The thermal additive may include inorganic fibers, expanded perlite, expanded vermiculite, expanded graphite, pumice, tuff, or a mixture thereof. In one embodiment, the thermal additive may include inorganic fibers. In another embodiment, the thermal additive may include at least one of expanded perlite, expanded vermiculite, or expanded graphite. For instance, the thermal additive may include expanded perlite in one embodiment. In another embodiment, the thermal additive may include expanded vermiculite. In a further embodiment, the thermal additive may include expanded graphite. In one embodiment, the thermal additive may include pumice, tuff, or a mixture thereof.

In one embodiment, the thermal additive may include a mixture of inorganic fibers and at least one other additive, such as expanded perlite, expanded vermiculite, expanded graphite, pumice, or tuff.

The inorganic fibers are not necessarily limited by the present disclosure. For instance, so long as such fibers provide a thermal barrier, they may be utilized in accordance with the present disclosure. In this regard, the inorganic fibers may comprise glass fibers, mineral fibers, ceramic fibers, or a mixture thereof.

In one embodiment, the inorganic fibers may comprise glass fibers. The glass fibers may be chopped glass fibers or glass filaments. In one embodiment, the glass fibers may be chopped glass fibers. In another embodiment, the glass fibers may be glass filaments.

In one embodiment, the inorganic fibers may comprise mineral fibers. The mineral fibers may comprise mineral wool, a silicate fiber, or a mixture thereof. In one embodiment, the mineral fibers may comprise mineral wool. The mineral wool may be rock wool, slag wool, or a mixture thereof. In one embodiment, the mineral fibers may comprise a silicate fiber. The silicate fiber may comprise a basalt fiber, a wollastonite fiber, or a mixture thereof. The silicate may be a nesosilicate, a sorosilicate, a cyclosilicate, an inosilicate, a phyllosilicate, a tectosilicate, or a mixture thereof. In one embodiment, the silicate may be an aluminosilicate.

In one embodiment, the inorganic fibers may comprise ceramic fibers. The ceramic fibers may be refractory ceramic fibers. The ceramic fibers may comprise titanium dioxide, silicon carbide, silicon nitride, boron nitride, or a mixture thereof.

The fibers may have a particular aspect ratio. For instance, the aspect ratio may be 1 or more, such as 2 or more, such as 3 or more, such as 4 or more, such as 5 or more, such as 7 or more, such as 10 or more, such as 15 or more, such as 20 or more. The aspect ratio may be 50 or less, such as 40 or less, such as 30 or less, such as 25 or less, such as 20 or less, such as 15 or less, such as 13 or less, such as 10 or less, such as 8 or less, such as 6 or less, such as 5 or less.

The fibers may have a particular diameter. For instance, the average diameter may be 1 μm or more, such as 2 μm or more, such as 3 μm or more, such as 4 μm or more, such as 5 μm or more, such as 7 μm or more, such as 10 μm or more, such as 15 μm or more, such as 20 μm or more. The average diameter may be 50 μm or less, such as 40 μm or less, such as 30 μm or less, such as 20 μm or less, such as 15 μm or less, such as 13 μm or less, such as 10 μm or less, such as 8 μm or less, such as 6 μm or less, such as 5 μm or less, such as 4 μm or less, such as 3 μm or less.

Further, the nominal diameter may be 1 μm or more, such as 2 μm or more, such as 3 μm or more, such as 4 μm or more, such as 5 μm or more, such as 7 μm or more, such as 10 μm or more, such as 15 μm or more, such as 20 μm or more. The nominal diameter may be 50 μm or less, such as 40 μm or less, such as 30 μm or less, such as 20 μm or less, such as 15 μm or less, such as 13 μm or less, such as 10 μm or less, such as 8 μm or less, such as 6 μm or less, such as 5 μm or less, such as 4 μm or less, such as 3 μm or less.

The fibers may have a particular length. For instance, the average length may be 0.01 cm or more, such as 0.05 cm or more, such as 0.1 cm or more, such as 0.3 cm or more, such as 0.5 cm or more, such as 0.8 cm or more, such as 1 cm or more, such as 2 cm or more, such as 3 cm or more. The average length may be 5 cm or less, such as 4 cm or less, such as 3.5 cm or less, such as 3 cm or less, such as 2.8 cm or less, such as 2.5 cm or less, such as 2.2 cm or less, such as 2 cm or less, such as 1.8 cm or less, such as 1.6 cm or less, such as 1.4 cm or less, such as 1.2 cm or less, such as 1 cm or less, such as 0.8 cm or less, such as 0.6 cm or less, such as 0.5 cm or less, such as 0.4 cm or less, such as 0.3 cm or less.

The thermal additive may be provided within the thermal barrier layer in a relatively high amount. For instance, a respective thermal additive be provided in the thermal barrier layer in an amount of 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more, such as 95 wt. % or more, such as 97 wt. % or more, such as 98 wt. % or more, such as 99 wt. % or more, such as about 100 wt. %. If other minor additives are utilized, they may be present in an amount of 20 wt. % or less, such as 15 wt. % or less, such as 10 wt. % or less, such as 8 wt. % or less, such as 6 wt. % or less, such as 4 wt. % or less, such as 3 wt. % or less, such as 2 wt. % or less, such as 1 wt. % or less.

In one embodiment, the thermal barrier layer may include the thermal additive in combination with the first filler as mentioned herein. In such scenario, the thermal additive may be provided in the thermal barrier layer in an amount of 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more, such as 95 wt. % or more, such as 97 wt. % or more, such as 98 wt. % or more, such as 99 wt. % or more, such as about 100 wt. %. The first filler may be provided in an amount of 50 wt. % or less, such as 40 wt. % or less, such as 30 wt. % or less, such as 20 wt. % or less, such as 15 wt. % or less, such as 10 wt. % or less, such as 8 wt. % or less, such as 6 wt. % or less, such as 4 wt. % or less, such as 3 wt. % or less, such as 2 wt. % or less, such as 1 wt. % or less.

When provided within the gypsum panel, the thermal barrier layer may not be bound. For instance, they may not be bound together using a binder (e.g., an acrylate). In this regard, they may be unbound. In another embodiment, the thermal barrier layer may be bound. For instance, the fibers may be bound together using a binder (e.g., an acrylate). Whether bound or unbound, the thermal barrier layer may be provided with water or sprayed with water while deposited onto the first facing material, such as the first paper facing material. The manner in which the components, such as the thermal additive such as the fibers, of the thermal barrier layer are provided is not necessarily limited. For instance, they may be dropped, deposited, broadcast, or provided using any other means generally known in the art. In addition, in one embodiment, as the thermal barrier may be provided prior to or immediately after providing a gypsum slurry, at least some of the additive within the thermal barrier layer may be embedded into the gypsum core and/or slurry. In particular, in one embodiment, as the thermal barrier may be provided prior to or immediately after providing a gypsum slurry for a dense layer or a highly concentrated layer, at least some of the additive within the thermal barrier layer may be embedded into the respective gypsum core and/or slurry. For instance, at the interface of the thermal barrier layer and a respective gypsum core/gypsum core layer and/or gypsum slurry, at least some of the additive with the thermal barrier layer may be embedded due to the fluid nature of the gypsum slurry.

In one embodiment, the thermal additives of the thermal barrier layer may be loosely provided as indicated herein. In another embodiment, the thermal additives, such as the inorganic fillers, may be provided as a sheet. The sheet may be a non-woven sheet. Accordingly, the thermal barrier layer may be provided as a non-woven sheet, such as a non-woven sheet of inorganic fibers as mentioned above, in one embodiment.

The thermal barrier layer may be provided in a particular amount. For instance, the thermal barrier layer may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more, such as 40 lbs/MSF or more. The thermal barrier layer may be present in an amount of 80 lbs/MSF or less, such as 70 lbs/MSF or less, such as 60 lbs/MSF or less, such as 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less.

Similarly, any respective component within the thermal barrier layer may be provided in a particular amount. For instance, the respective component may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more, such as 40 lbs/MSF or more. The respective component may be present in an amount of 100 lbs/MSF or less, such as 80 lbs/MSF or less, such as 70 lbs/MSF or less, such as 60 lbs/MSF or less, such as 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less.

In addition, a respective component within the thermal barrier layer may be provided in an amount of 0.001 lbs/ft² or more, such as 0.003 lbs/ft² or more, such as 0.005 lbs/ft² or more, such as 0.008 lbs/ft² or more, such as 0.01 lbs/ft² or more, such as 0.02 lbs/ft² or more, such as 0.03 lbs/ft² or more, such as 0.05 lbs/ft² or more, such as 0.08 lbs/ft² or more, such as 0.09 lbs/ft² or more. The respective component may be provided in an amount of 0.1 lbs/ft² or less, such as 0.08 lbs/ft² or less, such as 0.06 lbs/ft² or less, such as 0.04 lbs/ft² or less, such as 0.02 lbs/ft² or less, such as 0.01 lbs/ft² or less.

As indicated herein, the gypsum core is sandwiched by facing materials. The gypsum panel includes a first facing material, such as a first paper facing material. The first facing material may also be any other facing material as generally employed in the art. In addition, the second facing material may be any facing material as generally employed in the art. For instance, these facing materials may be a paper facing material, a fibrous (e.g., glass fiber) mat facing material, a polymeric facing material, or a metal facing material. In general, the first facing material and the second facing material may be the same type of material. Alternatively, the first facing material may be one type of material while the second facing material may be a different type of material.

In one embodiment, the first facing material may include a paper facing material. Alternatively, in another embodiment, the first facing material may be a glass mat facing material. In a further embodiment, the first facing material may be a polymeric facing material. In another further embodiment, the first facing material may be a metal facing material (e.g., an aluminum facing material).

In one embodiment, the second facing material may include a paper facing material. In this regard, both the first and second facing materials may be a paper facing material when the first facing material is also a paper facing material. Alternatively, in another embodiment, the second facing material may be a glass mat facing material. In a further embodiment, the second facing material may be a polymeric facing material. In another further embodiment, the second facing material may be a metal facing material (e.g., an aluminum facing material).

The glass mat facing material in one embodiment may be coated. However, in one particular embodiment, the glass mat facing material may not have a coating, such as a coating that is applied to the surface of the mat.

In one embodiment, the gypsum core, the thermal barrier layer, the first facing material, such as the first paper facing material, and the second facing material may be provided in a particular configuration. For instance, the first facing material, such as the first paper facing material, may have an outer surface and an inner surface opposing the outer surface. The thermal barrier layer may be provided adjacent the inner surface of the first facing material, such as the first paper facing material. For instance, in one embodiment, the thermal barrier layer may contact the inner surface of the first facing material, such as the first paper facing material. In addition, the gypsum core may have an outer surface facing the thermal barrier layer and an inner surface opposing the outer surface. In this regard, in one embodiment, the outer surface of the gypsum core may contact the thermal barrier layer. The second facing material may be provided adjacent to the inner surface of the gypsum core. In this regard, the second facing material may contact the inner surface of the gypsum core.

The gypsum panel may have another configuration in another embodiment. For instance, the first facing material, such as the first paper facing material, may have an outer surface and an inner surface opposing the outer surface. The gypsum core may have an outer surface facing the first facing material, such as the first paper facing material, and an inner surface opposing the outer surface. The thermal barrier layer may be provided adjacent the inner surface of the gypsum core. For instance, in one embodiment, the thermal barrier layer may contact the inner surface of the gypsum core. The second facing material may be provided adjacent to the thermal barrier layer. In this regard, the second facing material may contact the thermal barrier layer.

The gypsum panel may have an even further configuration in another embodiment. For instance, the gypsum panel may include two thermal barriers as defined herein. For instance, the first facing material, such as the first paper facing material, may have an outer surface and an inner surface opposing the outer surface. The first thermal barrier layer may be provided adjacent the inner surface of the first facing material, such as the first paper facing material. For instance, in one embodiment, the first thermal barrier layer may contact the inner surface of the first facing material, such as the first paper facing material. In addition, the gypsum core may have an outer surface facing the first thermal barrier layer and an inner surface opposing the outer surface. In this regard, in one embodiment, the outer surface of the gypsum core may contact the first thermal barrier layer. The second thermal barrier layer may be provided adjacent the inner surface of the gypsum core. For instance, in one embodiment, the second thermal barrier layer may contact the inner surface of the gypsum core. The second facing material may be provided adjacent to the second thermal barrier layer. In this regard, the second facing material may contact the second thermal barrier layer.

In general, the present disclosure is also directed to a method of making a gypsum panel. For instance, in the method of making a gypsum panel, the method may include a step of providing a first facing material, such as a first paper facing material. The first facing material, such as the first paper facing material may be conveyed on a conveyor system (i.e., a continuous system for continuous manufacture of gypsum panel).

Then, the method may include a step of providing or depositing a thermal barrier layer. For instance, when present between the first facing material, such as the first paper facing material, and the gypsum core, the method may include a step of providing or depositing a thermal barrier layer adjacent to or onto the first facing material, such as the first paper facing material, such as the inner surface of the first facing material, such as the first paper facing material. For instance, the thermal additive as defined herein may be deposited onto the first facing material, such as the first paper facing material. Similarly, when present between the gypsum core and the second facing material, the method may include a step of providing or depositing a thermal barrier layer adjacent to or onto a gypsum slurry as defined herein. For instance, the thermal additive as defined herein may be deposited onto the gypsum slurry as defined herein. The thermal additive may be provided or deposited using means generally known in the art. For instance, the thermal additive may be sprayed, dusted, or conveyed using other means known in the art. In addition, the thermal additive may be provided in a dry state. Alternatively, the thermal additive may be provided as a slurry in water. If provided in a dry state, the thermal additive may be sprayed with water or a solution. For instance, the spray may be a mist of water. When provided with water, the water may be provided as a composition including other components, such as dispersants, surfactants, wetting agents, foaming agents, etc. In particular, such components may be those as defined herein, particularly with respect to dispersants and/or foaming agents.

Thereafter, upon providing the thermal additive for forming the thermal barrier layer, a device may be utilized to spread the fibers into a relatively even layer across the length and width. For instance, upon depositing the thermal additive, a roll coater or other roll device may be utilized to relatively evenly/uniformly spread the thermal additive for forming the thermal barrier layer.

The method may also include a step of providing or depositing a gypsum slurry as defined herein. For instance, when the thermal barrier is present between the first facing material, such as the first paper facing material, and the gypsum core, the method may include a step of providing or depositing a gypsum slurry adjacent or onto the thermal barrier layer, such as in order to form and provide a gypsum core. Similarly, when the thermal barrier is present between the gypsum core and the second facing material, the method may include a step of providing or depositing a gypsum slurry adjacent to or onto the first facing material, such as the first paper facing material, such as in order to form and provide a gypsum core.

Then, the method may include a step of providing the second facing material. For instance, when the thermal barrier is present between the first facing material, such as the first paper facing material, and the gypsum core, the method may include a step of providing the second facing material adjacent to or onto the gypsum slurry. Similarly, when the thermal barrier is present between the gypsum core and the second facing material, the method may include a step of providing the second facing material adjacent to or onto the thermal barrier layer.

Next, the method may include a step of allowing the stucco to convert to calcium sulfate dihydrate to form a gypsum core. Also, the method may include drying the first facing material, such as the first paper facing material, the thermal barrier layer(s), the gypsum slurry and/or gypsum core, and the second facing material. Particularly, they may be dried simultaneously. Next, the first facing material, such as the first paper facing material, the thermal barrier layer(s), the gypsum core, and the second facing material may be cut such that the first facing material, such as the first paper facing material, the thermal barrier layer(s), the gypsum core, and the second facing material form a gypsum panel.

In general, the composition of the gypsum slurry and gypsum core is not necessarily limited and may be any generally known in the art. Generally, in one embodiment, the gypsum core is made from a gypsum slurry including at least stucco and water. However, as indicated herein, at least one gypsum slurry includes a first filler comprising silica, alumina, or a mixture thereof. In this regard, the method may include a step of also combining a first filler comprising silica, alumina, or a mixture thereof with the stucco, water, and any optional additives as indicated herein.

In general, stucco may be referred to as calcined gypsum or calcium sulfate hemihydrate. The calcined gypsum may be from a natural source or a synthetic source and is thus not necessarily limited by the present disclosure. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be α-hemihydrate, β-hemihydrate, or a mixture thereof.

In addition to the stucco, the gypsum slurry may also contain other hydraulic materials. These hydraulic materials may include calcium sulfate anhydrite, land plaster, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the hydraulic material.

As indicated above, the gypsum slurry may also include water. Water may be employed for fluidity and also for rehydration of the gypsum to allow for setting. The amount of water utilized is not necessarily limited by the present disclosure.

The weight ratio of the water to the stucco may be 0.1 or more, such as 0.2 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry also includes a first filler comprising silica, alumina, or a mixture thereof. The silica and alumina may be the silica and alumina as described above.

Generally, the first filler, such as the silica, may be present in the gypsum slurry in a particular amount. For instance, the first filler, such as the silica, may be present in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more, such as 0.45 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.5 wt. % or more, such as 2 wt. % or more, such as 3 wt. % or more, such as 4 wt. % or more, such as 5 wt. % or more. In some aspects, the first filler, such as the silica, may be present in an amount of 15 wt. % or less, such as 12 wt. % or less, such as 10 wt. % or less, such as 8 wt. % or less, such as 6 wt. % or less, such as 5 wt. % or less, such as 4 wt. % or less, such as 3 wt. % or less, such as 2 wt. % or less, such as 1.8 wt. % or less, such as 1.5 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.45 wt. % or less, such as 0.4 wt. % or less, such as 0.35 wt. % or less, such as 0.30 wt. % or less, such as 0.25 wt. % or less, such as 0.2 wt. % or less, such as 0.15 wt. % or less, such as 0.1 wt. % or less, such as 0.05 wt. % or less. In one embodiment, the aforementioned weight percentage may be based on the weight of the gypsum slurry. In another embodiment, the aforementioned weight percentage may be based on the solids content of the gypsum slurry. Moreover, the aforementioned weight percentage may be based on the weight of the stucco in the gypsum slurry.

In addition to the stucco, water, and first filler, the gypsum slurry may also include any other conventional additives as known in the art. In this regard, such additives are not necessarily limited by the present disclosure. For instance, the additives may include dispersants, foam or foaming agents including aqueous foam (e.g. sulfates such as alkyl sulfates, alkyl ether sulfates), set accelerators (e.g., ball mill accelerator, land plaster, sulfate salts, etc.), set retarders, binders, biocides (such as bactericides and/or fungicides), adhesives, pH adjusters, thickeners (e.g., Portland cement, fly ash, clay, celluloses and other fibers (e.g. cellulosic fibers, microfibrillated fibers, nanocellulosic fibers, etc.), high molecular weight polymers, etc.), leveling agents, non-leveling agents, starches (such as pregelatinized starch, non-pregelatinized starch, and/or an acid modified starch), colorants, fire retardants or additives (e.g., silicates, expandable materials such as vermiculite, perlite, graphite, etc.), water repellants, fillers (e.g., glass fibers), waxes (e.g., silicones, siloxanes, etc.), secondary phosphates (e.g., condensed phosphates or orthophosphates including trimetaphosphates, polyphosphates, and/or cyclophosphates, etc.), sound dampening polymers (e.g., viscoelastic polymers/glues, such as those including an acrylic/acrylate polymer, etc.; polymers with low glass transition temperature, etc.), mixtures thereof, natural and synthetic polymers, etc. In general, it should be understood that the types and amounts of such additives are not necessarily limited by the present disclosure.

Each additive may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. In one embodiment, the aforementioned weight percentage may be based on the weight of the gypsum slurry. In another embodiment, the aforementioned weight percentage may be based on the solids content of the gypsum slurry. In a further embodiment, the aforementioned weight percentage may be based on the stucco in the gypsum slurry.

In one embodiment, the gypsum slurry may contain an intumescent additive. The intumescent additive is not necessarily limited by the present disclosure. The intumescent additive may include a vermiculite, a perlite, a graphite, or a mixture thereof. In particular, such additive may be in an unexpanded form (also referred to as an expandable form). For example, the additive may be an unexpanded vermiculite, an unexpanded perlite, an unexpanded graphite, or a mixture thereof.

In one embodiment, the gypsum slurry may include unexpanded vermiculite. Such unexpanded vermiculite may be any suitable grade as known in the art. For instance, the unexpanded vermiculite may be a Grade 1 vermiculite, a Grade 2 vermiculite, a Grade 3 vermiculite, a Grade 4 vermiculite, a Grade 5 vermiculite or a mixture thereof. For instance, in one embodiment, the unexpanded vermiculite may be a Grade 1 vermiculite. In another embodiment, the unexpanded vermiculite may be a Grade 2 vermiculite. In a further embodiment, the unexpanded vermiculite may be a Grade 3 vermiculite. In another further embodiment, the unexpanded vermiculite may be a Grade 4 vermiculite. In a further embodiment, the unexpanded vermiculite may be a Grade 5 vermiculite.

In one embodiment, the unexpanded vermiculite may be a mixture of grades, such as a mixture of Grades 3 and 4, Grades 3 and 5, Grades 4 and 5, or Grades 3, 4, and 5. For instance, in one embodiment, the unexpended vermiculite may be a mixture of Grades 3 and 4. In another embodiment, the unexpended vermiculite may be a mixture of Grades 4 and 5. In a further embodiment, the unexpended vermiculite may be a mixture of Grades 3 and 5. In an even further embodiment, the unexpended vermiculite may be a mixture of Grades 3, 4, and 5.

In another embodiment, the gypsum slurry may not contain an intumescent additive. In one embodiment, the gypsum slurry may not contain a vermiculite, a perlite, and/or a graphite as mentioned above. For instance, the gypsum slurry may not contain a vermiculite in one embodiment. In another embodiment, the gypsum slurry may not contain a perlite. In one embodiment, the gypsum slurry may not contain graphite. In a further embodiment, the gypsum slurry may not contain at least any two of vermiculite, perlite, or graphite. In such embodiments, the amount may be 0.1 wt. % or less, such as 0.05 wt. % or less, such as 0.01 wt. % or less, such as 0.005 wt. % or less, such as 0.001 wt. % or less based on the weight of the gypsum slurry.

In one embodiment, the gypsum slurry may contain a vermiculite, a perlite, or a mixture thereof. In another embodiment, the gypsum slurry may not contain a vermiculite and/or a perlite. For instance, the gypsum slurry may not contain a vermiculite in one embodiment. In another embodiment, the gypsum slurry may not contain a perlite. In a further embodiment, the gypsum slurry may not contain vermiculite or perlite. In such embodiment, the amount may be 0.1 wt. % or less, such as 0.05 wt. % or less, such as 0.01 wt. % or less, such as 0.005 wt. % or less, such as 0.001 wt. % or less based on the weight of the gypsum slurry. In one embodiment, the aforementioned weight percentage may be based on the weight of the gypsum.

The foaming agent may be one generally utilized in the art. Such foaming agent may be combined with the stucco, water, and the first filler as defined herein. In this regard, such foaming agent may be present in the gypsum slurry as well as the resulting gypsum core and gypsum panel.

The foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate.

The alkyl sulfate may have a general formula as follows:

H(CH₂)ₙOSO₃⁻M⁺

wherein n is from 6 to 16 and M is a monovalent cation. In this regard, the alkyl sulfate includes alkyl chains. The alkyl may be linear, branched, or include a combination thereof. The average chain length of the alkyls may be 6 carbons or more, such as 7 carbons or more, such as 8 carbons or more, such as 9 carbons or more, such as 10 carbons or more, such as 11 carbons or more. The average chain length of the alkyls may be 15 carbons or less, such as 14 carbons or less, such as 13 carbons or less, such as 12 carbons or less, such as 11 carbons or less, such as 10 carbons or less, such as 9 carbons or less. In general, such average chain length is determined based on the length of the alkyl chains, not considering the length of any component of any alkyl ether sulfate that may be present. In addition, such average chain length is a weighted average chain length based on the amount of each specific alkyl present.

The monovalent cation may be sodium or ammonium. In one embodiment, the monovalent cation may be ammonium. In another embodiment, the monovalent cation may be sodium.

The alkyl ether sulfate may have a general formula as follows:

CH₃(CH₂)ₓCH₂—(OCH₂CH₂)_{y}—OSO₃⁻M⁺

wherein x is from 4 to 13, y is from 0.05 to 5, and M is a monovalent cation.

The alkyl portion of the alkyl ether sulfate may be 6 carbons or more, such as 7 carbons or more, such as 8 carbons or more, such as 9 carbons or more, such as 10 carbons or more, such as 11 carbons or more. Accordingly, x may be 4 or more, such as 5 or more, such as 6 or more, such as 7 or more, such as 8 or more, such as 9 or more, such as 10 or more. The alkyl portion of the alkyl ether sulfate may be 15 carbons or less, such as 14 carbons or less, such as 13 carbons or less, such as 12 carbons or less, such as 11 carbons or less, such as 10 carbons or less, such as 9 carbons or less. Accordingly, x may be 13 or less, such as 11 or less, such as 10 or less, such as 9 or less, such as 8 or less.

The ethoxylated content (y) of the alkyl ether sulfate may be 0.05 or more, such as 0.1 or more, such as 0.2 or more, such as 0.3 or more, such as 0.5 or more, such as 1 or more, such as 1.2 or more, such as 1.5 or more, such as 1.8 or more, such as 2 or more, such as 2.2 or more, such as 2.5 or more, such as 3 or more. The ethoxylated content of the alkyl ether sulfate may be 5 or less, such as 4.8 or less, such as 4.5 or less, such as 4.3 or less, such as 4 or less, such as 3.7 or less, such as 3.5 or less, such as 3.2 or less, such as 3 or less, such as 2.8 or less, such as 2.5 or less, such as 2.3 or less, such as 2 or less, such as 1.7 or less, such as 1.5 or less, such as 1.3 or less, such as 1 or less, such as 0.9 or less, such as 0.7 or less.

The monovalent cation may be sodium or ammonium. In one embodiment, the monovalent cation may be ammonium. In another embodiment, the monovalent cation may be sodium.

When a mixture of an alkyl sulfate and an alkyl ether sulfate is present, the alkyl ether sulfate may be present in an amount of from more than 0 wt. % to less than 100 wt. %. For instance, in the mixture, the alkyl ether sulfate may be present in an amount of more than 0 wt. %, such as 0.01 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more. In the mixture, the alkyl ether sulfate may be present in an amount of less than 100 wt. %, such as 95 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less. Such weight percentage may be based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 0.001 or more, such as 0.005 or more, such as 0.01 or more, such as 0.05 or more, such as 0.1 or more, such as 0.2 or more, such as 0.3 or more, such as 0.5 or more, such as 1 or more, such as 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less, such as 3 or less, such as 2 or less, such as 1 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

By utilizing a soap, foaming agent, and/or foam as disclosed herein, the gypsum slurry may include bubbles or voids having a particular size. Such size may then contribute to the void structure in the gypsum panel and the resulting properties.

In one aspect, the foam may be provided in an amount of 1 lb/MSF or more, such as 5 lbs/MSF or more, such as 10 lbs/MSF or more, such as 15 lbs/MSF or more, such as 20 lbs/MSF or more, such as 25 lbs/MSF or more, such as 30 lbs/MSF or more, such as 50 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less, such as 80 lbs/MSF or less, such as 60 lbs/MSF or less, such as 50 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include at least one dispersant. The dispersant is not necessarily limited and may include any that can be utilized within the gypsum slurry. The dispersant may include carboxylates, sulfates, sulfonates, phosphates, mixtures thereof, etc. For instance, in one embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof. In another embodiment, the dispersant may include a carboxylate, such as a carboxylate ether and in particular a polycarboxylate ether or a carboxylate ester and in particular a polycarboxylate ester. In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include a starch. The starch may be one generally utilized in the art. Such starch may be combined with the stucco, water, and the first filler as defined herein. In this regard, such starch may be present in the gypsum slurry as well as the resulting gypsum core and gypsum panel.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example. In one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 50° C. or more, such as 60° C. or more, such as 80° C. or more, such as 100° C. or more, such as 120° C. or more, such as 140° C. or more, such as 160° C. or more, such as 180° C. or more. The gelling temperature may be 300° C. or less, such as 260° C. or less, such as 220° C. or less, such as 200° C. or less, such as 180° C. or less, such as 160° C. or less, such as 140° C. or less, such as 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively higher gelling temperature. Meanwhile, without intending to be limited by theory, modifications of the hydroxyl group, such as by replacement via ethoxylation, ethylation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present disclosure.

In one aspect, the starch may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less.

The manner in which the components (e.g., stucco, water, first filler as defined herein) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present disclosure. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Furthermore, regarding the first filler, it may be provided as a solid. Alternatively, it may be provided as a dispersion or slurry in water. In particular, the water utilized for providing the first filler may be the same water as that utilized to provide the foaming agent or any other components. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

In addition, the calcium sulfate hemihydrate reacts with the water to hydrate the calcium sulfate hemihydrate into a matrix of calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal of any free water. The temperature and time required for drying in a heating device is not necessarily limited by the present disclosure.

In one embodiment, the gypsum core may include a first gypsum core layer and a second gypsum core layer. The first gypsum core layer may be between the first facing material, such as the first paper facing material, (i.e., front of the gypsum panel)/thermal barrier layer and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (i.e., back of the gypsum panel)/thermal barrier layer (if present). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Generally, the first gypsum core layer, the second gypsum core layer, and/or the third gypsum core layer may contain any of the additives as disclosed herein, such as the first filler as defined herein. Further, the first gypsum core layer, the second gypsum core layer, and/or the third gypsum core layer may contain an additive in an amount as previously indicated herein.

As indicated herein, the gypsum core can include a first filler as defined herein. In this regard, in one embodiment, the first gypsum core layer may include a first filler as defined herein. In another embodiment, the second gypsum core layer may include a first filler as defined herein. In a further embodiment, the third gypsum core layer may include a first filler as defined herein. In an even further embodiment, the first gypsum core layer and the second gypsum core layer may include a first filler as defined herein. In another further embodiment, the first gypsum core layer, the second gypsum core layer, and the third gypsum core layer may include a first filler as defined herein. In yet another embodiment, a first filler as defined herein may be included adjacent to the first facing material, such as the first paper facing material, and/or the second facing material.

Regardless of the above, a first filler as defined herein may be present in any combination of gypsum core layers. However, in one embodiment, it should be understood that one or two of the aforementioned gypsum core layers may not include a first filler as defined herein. In one aspect, one or more gypsum core layers may comprise the same first filler as defined herein. Further, in one aspect, the one or more gypsum core layers may comprise different first filler as defined herein. The different first filler of the one or more gypsum core layers may be chosen such that it is advantageous to have a particular first filler in one gypsum core layer and a different first filler in another, different gypsum core layer.

The gypsum panel disclosed herein may have many applications. For instance, the gypsum panel may be used as a standalone panel in construction for the preparation of walls, ceilings, floors, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

The specific surface area of the gypsum core is not necessarily limited and may be from about 0.25 m²/g to about 15 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present disclosure is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 10 pcf or more, such as about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396 and ASTM C473. The gypsum panel may have an edge hardness of about 50 lb or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396 and ASTM C473. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

### EXAMPLES

### Example 1

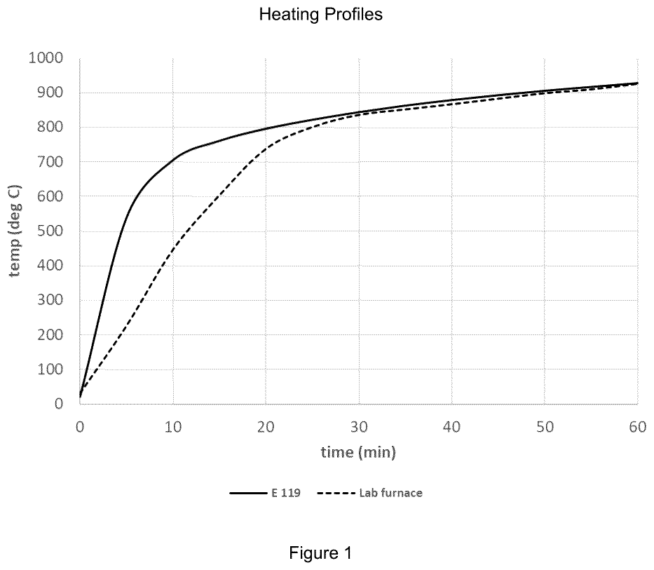

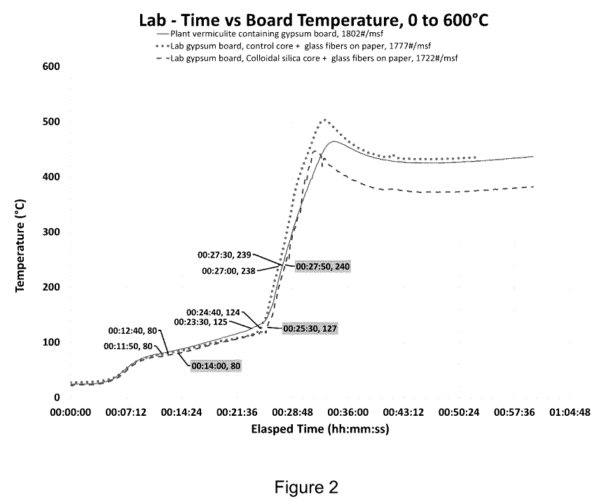

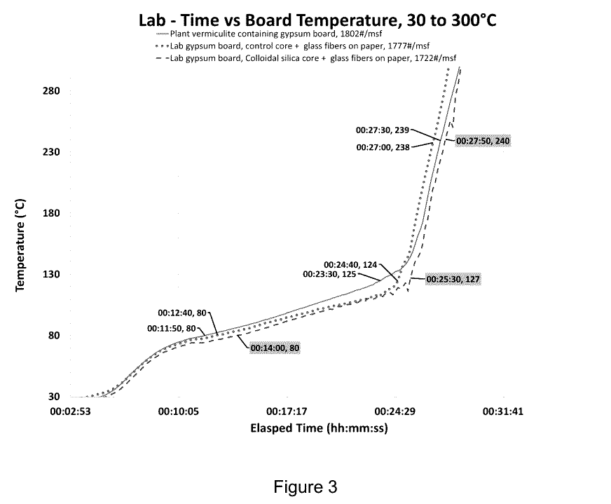

Gypsum panels were made in accordance with the descriptions below. The gypsum panels were analyzed to determine the fire resistance. For the testing, a 12″×12″ sample was mounted onto a muffle furnace wall and subjected to the “Lab furnace” heating profile of FIG. 1. FIG. 1 also demonstrates a standard heating profile in accordance with ASTM E119-20a. The table below indicates the time required to reach key temperatures on the thermocouple attached to the outside of the gypsum panel sample as well as the approximate failure point. The temperature of the gypsum panels as a function of time is illustrated in FIGS. 2 and 3.

| | Board | Time to | Time to | Time to |
|---|---|---|---|---|
| | weight | 80° C., | 125° C., | 232° C., |
| Sample | (lbs/msf) | (hh:mm:ss) | (hh:mm:ss) | (hh:mm:ss) |
| Control gypsum | 1802 | 00:11:52 | 00:23:37 | 00:27:28 |
| panel including | | | | |
| Grade 5 | | | | |
| vermiculite | | | | |
| (60 lbs) | | | | |
| in the core | | | | |
| Control gypsum | 1777 | 00:12:40 | 00:24:40 | 00:27:00 |
| panel with glass | | | | |
| fibers on paper | | | | |
| facing material | | | | |
| (no vermiculite) | | | | |
| Gypsum panel | 1722 | 00:14:00 | 00:25:30 | 00:27:50 |
| with silica | | | | |
| (2 wt. % based | | | | |
| on stucco) in the | | | | |
| core + glass | | | | |
| fibers (0.04 lbs/ | | | | |
| ft²) on paper | | | | |
| facing material | | | | |
| (no vermiculite) | | | | |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising:
a first facing material having an outer surface and an inner surface opposing the outer surface;
a thermal barrier layer adjacent the inner surface of the first facing material, the thermal barrier layer comprising a thermal additive;
a gypsum core having an outer surface facing the thermal barrier layer and an inner surface opposing the outer surface, the gypsum core comprising a first filler comprising silica, alumina, or a mixture thereof; and
a second facing material adjacent the inner surface of the gypsum core.

2. The gypsum panel of claim 1, wherein the thermal additive comprises an inorganic fiber.

3. The gypsum panel of claim 2, wherein the inorganic fiber comprises glass fibers, mineral fibers, ceramic fibers, or a mixture thereof.

4. The gypsum panel of claim 2, wherein the inorganic fiber has a nominal diameter of from 5 μm or more to 30 μm or less.

5. The gypsum panel of claim 2, wherein the inorganic fiber has an average length of from 0.3 cm or more to 4 cm or less.

6. The gypsum panel of claim 1, wherein the thermal additive is unbound.

7. The gypsum panel of claim 1, wherein the thermal additive is bound by a binder.

8. The gypsum panel of claim 1, wherein the thermal barrier layer comprises a non-woven sheet.

9. The gypsum panel of claim 1, wherein the thermal barrier layer is present in an amount of 10 lbs/MSF or more to 50 lbs/MSF or less.

10. The gypsum panel of claim 1, wherein the thermal additive comprises glass fibers.

11. The gypsum panel of claim 1, wherein the thermal additive comprises mineral fibers.

12. The gypsum panel of claim 1, wherein the thermal additive comprises ceramic fibers.

13. The gypsum panel of claim 1, wherein the first filler comprises silica.

14. The gypsum panel of claim 13, wherein the silica has an average particle size of from 3 nm or more to 100 nm or less.

15. The gypsum panel of claim 13, wherein the silica has an average particle size of from 5 nm or more to 20 nm or less.

16. The gypsum board of claim 13, wherein the silica is a colloidal silica, a precipitated silica, or a mixture thereof.

17. The gypsum panel of claim 1, wherein the first filler comprises alumina.

18. The gypsum panel of claim 1, wherein the first filler comprises a mixture of silica and alumina.

19. The gypsum panel of claim 1, wherein the first filler is present in the gypsum core in an amount of from 0.001 wt. % or more to 15 wt. % or less based on the weight of the gypsum core.

20. The gypsum panel of claim 1, wherein the first facing material comprises a paper facing material.

21. The gypsum panel of claim 1, wherein the second facing material comprises a paper facing material.

22. The gypsum panel of claim 1, wherein the gypsum core further comprises vermiculite.

23. A method of making the gypsum panel of claim 1, the method comprising:
providing the first facing material;
depositing the thermal additive adjacent the inner surface of the first facing material to form the thermal barrier layer;
depositing a gypsum slurry comprising stucco, water, and the first filler comprising silica, alumina, or a mixture thereof adjacent the thermal barrier layer;
providing the second facing material adjacent the gypsum slurry; and
allowing the stucco to convert to calcium sulfate dihydrate to form the gypsum core.
